(19) United States
(12) Patent Application Publication
(10) Pub. No.: US 2021/0304104 A1
(43) Pub. Date: Sep. 30, 2021

(54) WORK MONITORING SYSTEM

(71) Applicant: TOSHIBA TEC KABUSHIKI KAISHA, Tokyo (JP)

(72) Inventor: Atsushi OKAMURA, Mishima Shizuoka (JP)

(21) Appl. No.: 17/198,882

(22) Filed: Mar. 11, 2021

(30) Foreign Application Priority Data
Mar. 25, 2020 (JP) 2020-053674

(51) Int. Cl. G06Q 10/06; G06K 7/10; G06K 9/00; H04N 7/18

(52) U.S. Cl. CPC G06Q 10/06393; G06K 7/10297; H04N 7/18; G06K 9/00771; G06K 9/00335

(57) ABSTRACT

According to an embodiment, a work monitoring system monitors work in a work zone where the work is performed in accordance with a work instruction on a work target conveyed from the work zone to a correction zone where the work is corrected. The work monitoring system determines, on the basis of a result of monitoring the work, whether or not inappropriate work different from work designated by the work instruction has been performed and identifies the work target that is a target of the work.

### CROSS-REFERENCE TO RELATED APPLICATIONS

This application is based upon and claims the benefit of priority from the prior Japanese Patent Application No. 2020-053674, filed on Mar. 25, 2020, the entire contents of which are incorporated herein by reference.

### FIELD

An embodiment to be described here generally relates to a work monitoring system.

### BACKGROUND

In a logistics base, a worker takes out an article designated by a voucher from a place where various articles are kept and sorts the article into a container for delivery, i.e., so-called picking work is performed. In order to smoothly perform this picking work, a system in which an indicator such as a lamp is used to indicate a place where an article to be taken out is kept and a container of a sorting destination has been put into practical use.

However, the work is not necessarily performed as instructed, and an artificial mistake may occur. As a technology for detecting such a mistake, there is a system for monitoring an abnormal behavior of a person. This monitoring system checks the behavior of the person by using an image, and immediately notifies the person of a mistake when an inappropriate behavior is detected. Therefore, in the case where the worker performs work different from work designated by the work instruction, it is advantageous if the mistake can be corrected immediately.

However, in many logistics bases, the picking work is performed while the container for delivery is moved in one direction by a conveyor. For this reason, if the work of correcting the mistake is performed at the site of the picking work, the flow of the conveyor may be stopped. Therefore, the monitoring system as described above cannot be applied.

### BRIEF DESCRIPTION OF THE DRAWINGS

FIG. 1 is a diagram showing an example of a configuration of a logistics base system including a work monitoring system according to an embodiment;

FIG. 2 is a diagram showing an example of a configuration of a logistics base into which the logistics base system according to the embodiment is introduced;

FIG. 3 is a diagram schematically showing an example of a display unit attached to an article box according to the embodiment;

FIG. 4 is a diagram schematically showing an example of a display unit attached to a container according to the embodiment;

FIG. 5 is a diagram schematically showing a data structure of an article record stored in an article database according to the embodiment;

FIG. 6 is a diagram schematically showing a data structure of a voucher record stored in a voucher database according to the embodiment;

FIG. 7 is a block diagram showing a configuration of a preparation zone facility in the logistics base system according to the embodiment;

FIG. 8 is a diagram schematically showing a data structure of a work list stored in the preparation zone facility according to the embodiment;

FIG. 9 is a block diagram showing a configuration of a work zone facility in the logistics base system according to the embodiment;

FIG. 10 is a diagram schematically showing a data structure of a tracking list stored in the work zone facility according to the embodiment;

FIG. 11 is a diagram schematically showing a data structure of an inappropriate-information list stored in the work zone facility according to the embodiment;

FIG. 12 is a block diagram showing a configuration of a collection zone facility in the logistics base system according to the embodiment;

FIG. 13 is a flowchart showing information processing of a preparation controller according to the embodiment;

FIG. 14 is a flowchart showing information processing of a work controller according to the embodiment;

FIG. 15 is a flowchart showing the information processing of the work controller according to the embodiment; and

FIG. 16 is a flowchart showing information processing of a collection controller according to the embodiment.

### DETAILED DESCRIPTION

According to an embodiment, a work monitoring system monitors work of a worker on a work target conveyed from a work zone where the work is performed in accordance with a predetermined work instruction to a correction zone where the work is corrected. The work monitoring system includes a monitoring camera, a storage device, a detector, a notifier, and a controller. The monitoring camera captures an image of a behavior of the worker on the work target. The storage device stores tracking data including content of the work instruction for the worker in association with the work target to track the behavior of the worker. The detector detects the work target conveyed to the correction zone. The notifier notifies that inappropriate work different from work designated by the work instruction has been performed on the work target. The controller monitors the work of the worker in the work zone on the basis of the image captured by the monitoring camera. The controller determines whether or not the inappropriate work on the work target has been performed by the worker on the basis of a result of monitoring the work and the tracking data stored in the storage device. The controller identifies, where it is determined that the inappropriate work on the work target has been performed, the work target on which the inappropriate work has been performed, on the basis of the result. Further, the controller operates, where it is determined that the identified work target has been conveyed to the correction zone, the notifier on the basis of a detection result of the detector.

Hereinafter, a work monitoring system according to an embodiment will be described with reference to the drawings. In the drawings, the same reference symbols indicate the same or similar portions. Note that this embodiment is a work monitoring system for a logistics base in which picking work is performed while moving a container for delivery in one direction by a conveyor.

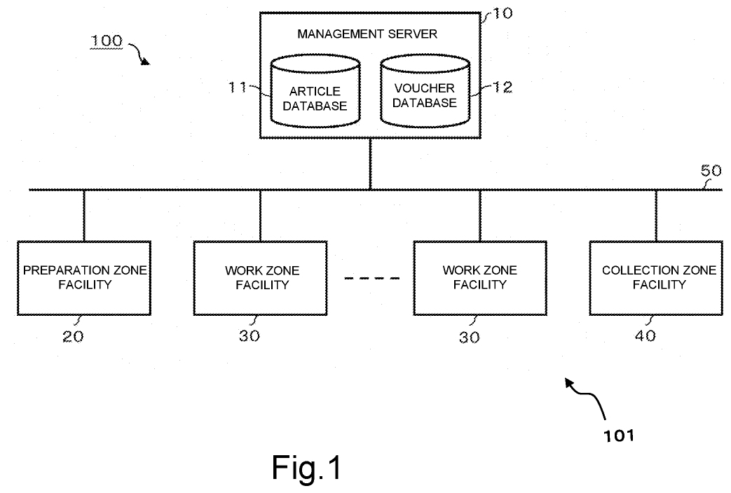

FIG. 1 is a diagram showing a schematic configuration of a logistics base system 100 including a work monitoring system 101 according to an embodiment. The logistics base system 100 includes a management server 10, a preparation zone facility 20, a plurality of work zone facilities 30, a collection zone facility 40, and a communication network 50. Further, the work monitoring system 101 includes the work zone facility 30 and the collection zone facility 40 of the logistics base system 100. The communication network 50 is, for example, a local area network (LAN). The communication network 50 may be a wide area network (WAN) such as the Internet and an intranet. In this case, the communication network 50 may include a telephone communication network or a mobile communication network. Alternatively, the communication network 50 may include a combination of the telephone communication network and the mobile communication network. In the logistics base system 100, the preparation zone facility 20, the plurality of work zone facilities 30, and the collection zone facility 40 are connected to the management server 10 via the communication network 50.

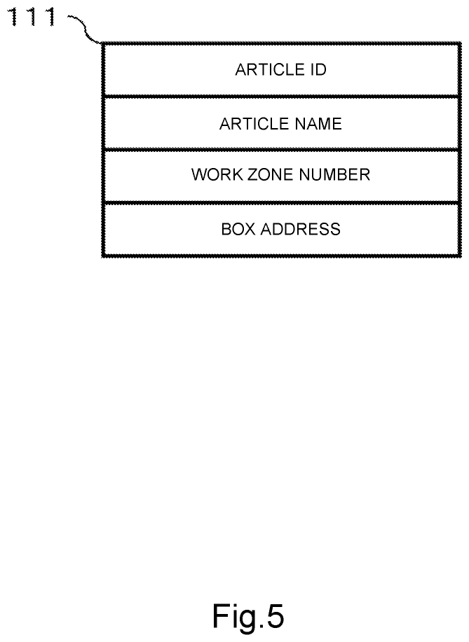

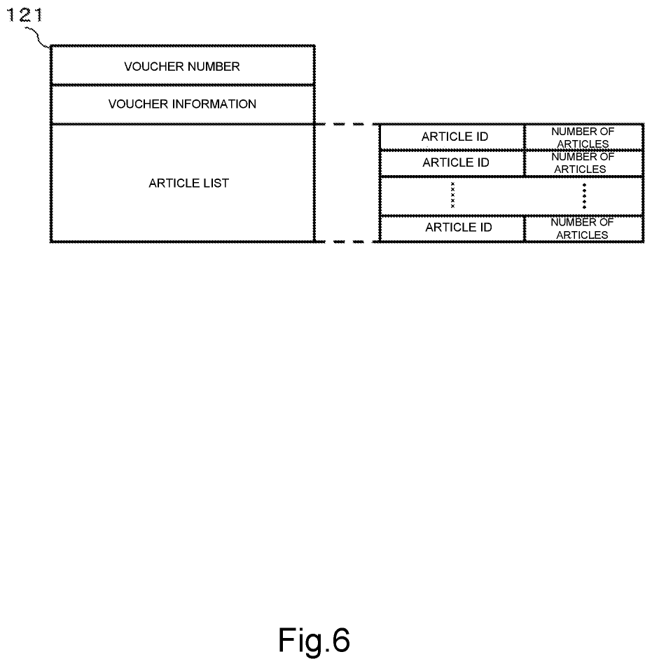

The management server 10 manages an article database 11 and a voucher database 12. The article database 11 is a collection of article records 111 (see FIG. 5) created for each article handled in the logistics base. The voucher database 12 is a collection of voucher records 121 (see FIG. 6) created for each voucher on which order information from an orderer is recorded. The article record 111 and the voucher record 121 will be described below.

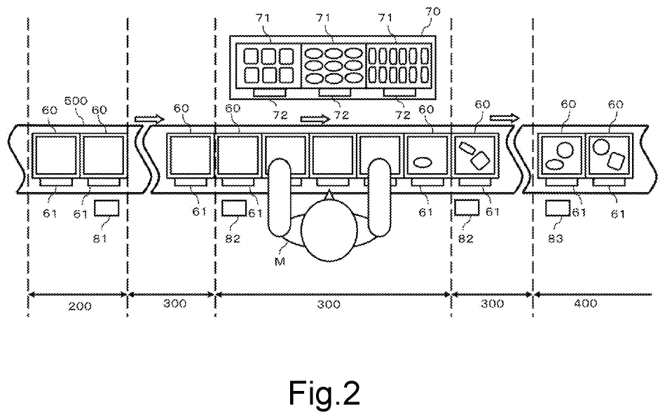

FIG. 2 is a diagram showing a configuration of a logistics base into which the logistics base system 100 according to the embodiment is introduced. In the logistics base according to the embodiment, articles such as foodstuffs and commodities are handled. In the logistics base, the article ordered by the orderer is packed into a container 60 for delivery.

As shown in FIG. 2, the logistics base is divided into a preparation zone 200, a plurality of work zones 300, and a collection zone 400. The preparation zone 200 is located on the upstream side with respect to the flow direction of the container 60 indicated by arrows in FIG. 2, and the collection zone 400 is located on the downstream side. The plurality of work zones 300 is disposed side by side along the flow direction of the container 60 between the preparation zone 200 and the collection zone 400.

The logistics base is equipped with a conveyor 500 from the preparation zone 200 to the collection zone 400 through the respective work zones 300. The conveyor 500 conveys the containers 60 in tandem from the preparation zone 200 to the collection zone 400 through the respective work zones 300.

The preparation zone 200 is a zone for preparing the container 60. The work zone 300 is a zone for taking out an article designated by a voucher from the place where various articles are kept and sorting the article into the container 60, i.e., a zone for performing so-called picking work. The collection zone 400 is a zone for collecting the container 60 on which the picking work has been performed. In the collection zone 400, in the case where there is a mistake in the picking work on the collected container 60, the work of correcting the mistake is performed. That is, the collection zone 400 is also a correction zone. Note that the work zones 300 have the same basic configuration. In FIG. 2, one work zone 300 is specifically shown, and the illustration of the other work zones 300 is simplified.

In each of the work zones 300, a worker M performs picking work. In this regard, an article shelf 70 is installed in each of the work zones 300. The article shelf 70 is located at a position facing the worker M with the conveyor 500 interposed therebetween. A plurality of article boxes 71 is placed on the article shelf 70. In each of the article boxes 71, articles of different types are sorted for each box and kept.

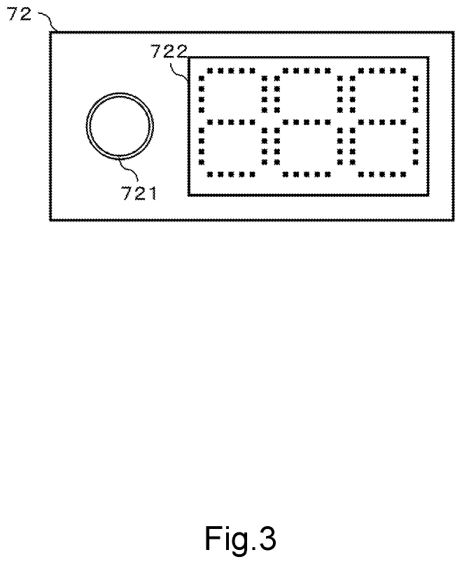

A display unit 72 is attached to the article box 71. FIG. 3 is a diagram showing an example of the display unit 72. The display unit 72 includes a lamp 721 and a numerical-value indicator 722. The lamp 721 is an indicator for instructing the worker M to take out an article from the article box 71 to which the display unit 72 is attached. The numerical-value indicator 722 is an indicator for informing the worker M of the number of articles to be taken out from the article box 71. For example, the worker M takes out, when the lamp 721 is turned on, the article(s) from the article box 71 where the lamp 721 is turned on, the number of articles to be taken out being displayed on the numerical-value indicator 722. For this reason, the display unit 72 is attached to a place where the worker M can easily view the lamp 721 and the numerical-value indicator 722.

The container 60 is formed of, for example, polystyrene foam or corrugated board. The containers 60 are conveyed in tandem by the conveyor 500 from the preparation zone 200 to the collection zone 400 through the respective work zones 300. The container 60 may be conveyed alone or may be conveyed while being supported by a support member. Further, the size and shape of the container 60 are not particularly limited. The containers 60 of different sizes or shapes may be conveyed together.

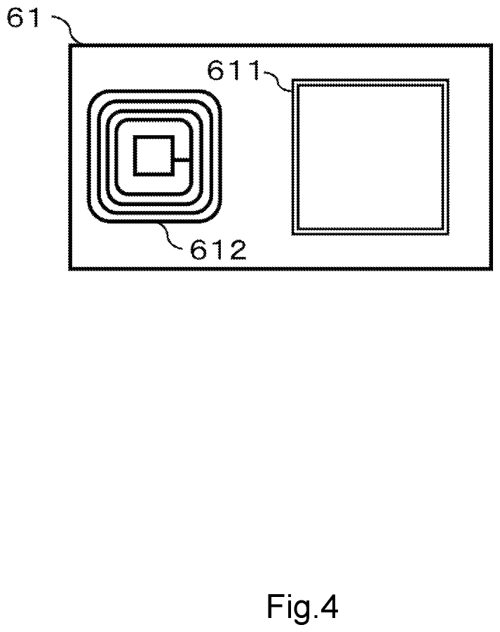

A display unit 61 is attached to the container 60. FIG. 4 is a diagram showing an example of the display unit 61. The display unit 61 includes a lamp 611 and a radio tag, e.g., a RFID (Radio Frequency IDentification) tag 612. The lamp 611 is an indicator for instructing the worker M to put an article into the container 60 to which the display unit 61 is attached. For example, the worker M puts, when the lamp 611 is turned on, the article taken out from the article box 71 into the container 60 where the lamp 611 is turned on. For this reason, the display unit 61 is attached to a place where the worker M can easily view the lamp 611. Note that in the case where the container 60 is conveyed while being supported by a support member, the display unit 61 may be attached to the support member.

The RFID tag 612 shown in FIG. 4 is a non-contact recording medium capable of writing data and reading data by a dedicated reader/writer. As shown in FIG. 2, in the logistics base system 100, a plurality of reader/writers 81, 82, and 83 is disposed along the longitudinal direction of the conveyor 500, i.e., the conveying direction of the container 60.

In detail, the reader/writer 81 is disposed in the vicinity of the outlet of the preparation zone 200. The reader/writer 81 writes data to the RFID tag 612 corresponding to the container 60 conveyed from the preparation zone 200 to the work zone 300 of the first stage, i.e., the RFID tag 612 (see FIG. 4) of the display unit 61 attached to the container 60.

The reader/writer 82 is disposed in the vicinity of the entrance of each of the work zones 300. The reader/writer 82 reads data from the RFID tag 612 corresponding to the container 60 conveyed from the zone on the upstream side to the work zone 300, i.e., the RFID tag 612 of the display unit 61 attached to the container 60.

The reader/writer 83 is a detector that detects the container 60 conveyed to the collection zone (correction zone) 400. Specifically, the reader/writer 83 is disposed in the vicinity of the entrance of the collection zone 400. The reader/writer 83 reads data from the RFID tag 612 corresponding to the container 60 conveyed from the work zone 300 of the last stage to the collection zone 400, i.e., the RFID tag 612 of the display unit 61 attached to the container 60.

FIG. 5 is a diagram schematically showing a data structure of the article record 111. As shown in FIG. 5, the article record 111 includes items such as an article ID, an article name, a work zone number, and a box address. The article ID is an identification code set for each article in order to individually identify each article handled in the logistics base. The article name is a unique name of the article. The work zone number is a series of numbers set for each of the work zones 300 to individually identify the plurality of work zones 300. The box address is information for identifying the positions of the respective article boxes 71 placed on the article shelf 70 of the work zone 300. That is, the article record 111 includes the article name of the article identified by the article ID, the work zone number of the work zone 300 in which the article is placed, and the box address of the article box 71 in which the article is kept. Note that the items included in the article record 111 are not limited to the article ID, the article name, the work zone number, and the box address. The article record 111 may include other items.

FIG. 6 is a diagram schematically showing a data structure of the voucher record 121. As shown in FIG. 6, the voucher record 121 includes items of a voucher number, voucher information, and an article list. The voucher number is an identification number of the voucher. The voucher information is information relating to a voucher, such as the orderer, the order date, the delivery date, and the delivery destination. The article list is a list of the article IDs and the number of articles ordered by the orderer. The article list may include an article name. That is, the voucher record 121 includes voucher information of the voucher identified by the voucher number and the article list. Note that the items included in the voucher record 121 are not limited to the voucher number, the voucher name, and the article list. The voucher record 121 may include other items.

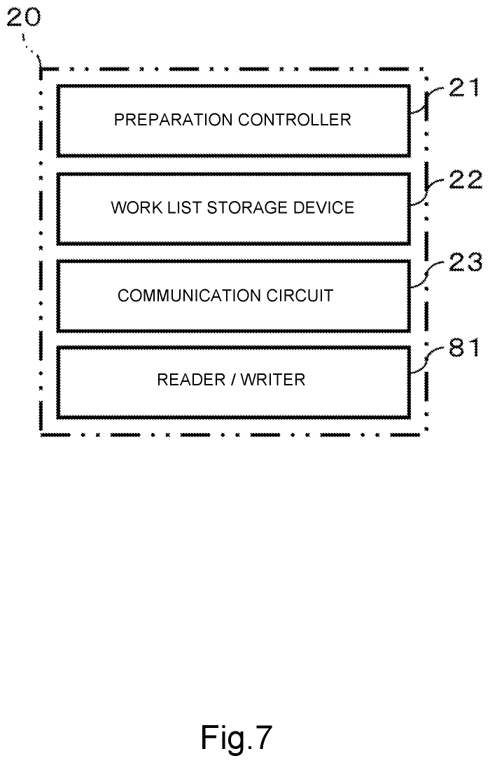

Next, the preparation zone facility 20, the work zone facility 30, and the collection zone facility 40 will be described. FIG. 7 is a block diagram showing a configuration of the preparation zone facility 20. The preparation zone facility 20 includes a preparation controller 21, a work list storage device 22, a communication circuit 23, and the above-mentioned reader/writer 81.

The preparation controller 21 realizes the function as the preparation zone facility 20 by controlling the respective units in accordance with a control program. The preparation controller 21 mainly includes a processor and a main memory. The processor is, for example, a central processing unit (CPU). The main memory is, for example, a read only memory (ROM) and a random access memory (RAM).

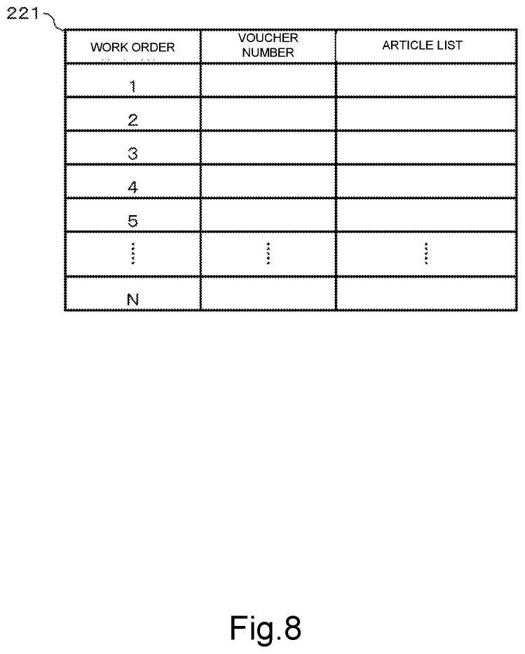

The work list storage device 22 stores a work list 221 (see FIG. 8). As shown in FIG. 8, the work list 221 is one in which voucher numbers and article lists are described in the order of the work order. The work list 221 is created on the basis of the voucher record 121 (see FIG. 6) stored in the voucher database 12. The work list storage device 22 is a volatile memory. Specifically, the work list storage device 22 is, for example, a RAM. The work list storage device 22 may be a secondary storage device.

The communication circuit 23 is a circuit for performing data communication with the management server 10 (see FIG. 1) connected by the communication network 50.

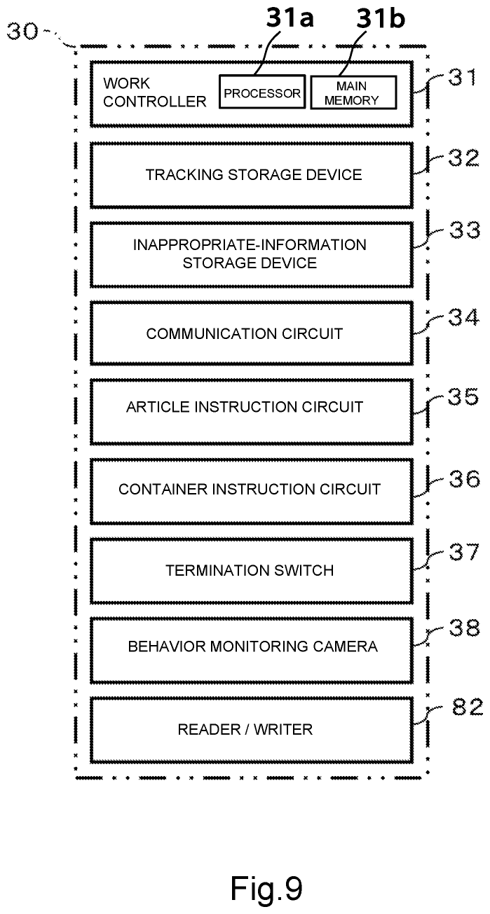

FIG. 9 is a block diagram showing a configuration of the work zone facility 30. The work zone facility 30 includes a work controller 31, a tracking storage device 32, an inappropriate-information storage device 33, a communication circuit 34, an article instruction circuit 35, a container instruction circuit 36, a termination switch 37, a behavior monitoring camera 38, and the above-mentioned reader/writer 82.

The work controller 31 shown in FIG. 9 realizes the function as the work zone facility 30 by controlling the respective units in accordance with the control program. The work controller 31 mainly includes a processor and a main memory. A processor 31a is, for example, a CPU. A main memory 31b is, for example, a ROM and a RAM. The RAM of the main memory 31b is used as, for example, a work memory MA, a work memory MB, a work memory MC, and a work memory MD, which will be described below.

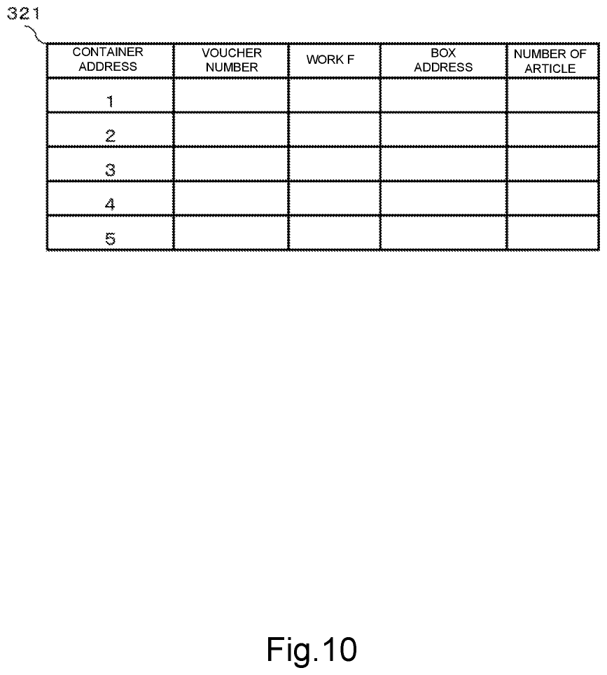

The tracking storage device 32 shown in FIG. 9 stores a tracking list 321 (see FIG. 10). As shown in FIG. 10, the tracking list 321 is one in which a voucher number, a work flag, a box address, and the number of articles are described in association with a container address. Hereinafter, data describing a voucher number, a work flag, a box address, and the number of articles in association with a container address will be referred to as tracking data.

The container address shown in FIG. 10 is information for identifying the position of the container 60 conveyed in the work zone 300. The container address is, for example, a sequence number from The largest number of the container address is the number of containers 60 that can be located in the work zone 300. For example, in FIG. 2, the number of containers 60 that can be located in the work zone 300 where the worker M performs work is five. Therefore, for the five containers 60 conveyed from left to right on the conveyor 500, the position of the leftmost container 60 is the address “1”. The position of the container 60 on the right side of the leftmost container 60 is the address “2”. Similarly, the positions of the containers 60 shifted in order to the right are the address “3”, the address “4”, and the address “5”.

The voucher number shown in FIG. 10 is the number of the voucher assigned to the container 60 located at the position of the corresponding container address. The work F (flag) is 1-bit data for identifying whether or not picking work occurs in the work zone 300 of the work zone facility 30. In the embodiment, the work flag when the picking work occurs is set to “1”. Therefore, the work flag when no picking work occurs is set to “0”.

The box address and the number of articles are respectively a box address indicating the position of the article box 71 in which the article to be worked is kept and the number of kept articles when picking work occurs in the work zone 300 of the work zone facility 30. The box address is obtained from the article record 111 (see FIG. 5). The number of articles is obtained from the article list of the voucher record 121 (see FIG. 6).

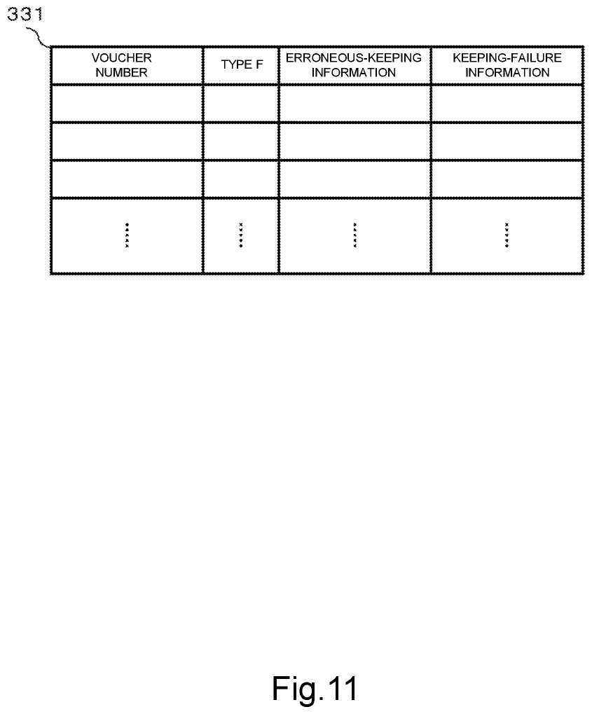

The inappropriate-information storage device 33 shown in FIG. 9 stores an inappropriate-information list 331 (see FIG. 11). As shown in FIG. 11, the inappropriate-information list 331 is one in which a type F (flag), erroneous-keeping information, and keeping-failure information are described in association with a voucher number. The type flag is information for identifying the type of inappropriate information.

The inappropriate information includes inappropriate-work information and inappropriate-work correction information. The inappropriate-work information is information indicating the content of inappropriate work performed on the container 60 that is the work target. The inappropriate-work correction information is information indicating the content of work for correcting the inappropriate work.

In the work zone 300 shown in FIG. 2, the following work is assumed as inappropriate work.

### [Inappropriate Work 1]

In response to a work instruction to put an article A into a container P, the worker M puts the article A into a container Q.

### [Inappropriate Work 2]

In response to a work instruction to put the article A into the container P, the worker M puts an article B into the container P.

### [Inappropriate Work 3]

In response to a work instruction to put the article A into the container P, the worker M puts the article B into the container Q.

In the case of the [Inappropriate work 1], the inappropriate-work information includes keeping-failure work information indicating that “there is a failure in keeping the article A in the container P” and erroneous-keeping work information indicating that “the article A is erroneously kept in the container Q”. Further, the inappropriate-work correction information includes keeping-failure correction information indicating that “the article A is to be put into the container P” and erroneous-keeping correction information indicating that “the article A is to be removed from the container Q”.

In the case of the [Inappropriate work 2], the inappropriate-work information includes keeping-failure work information indicating that “there is a failure in keeping the article A in the container P” and erroneous-keeping work information indicating that “the article B is erroneously kept in the container P”. Further, the inappropriate-work correction information includes keeping-failure correction information indicating that “the article A is to be put into the container P” and erroneous-keeping correction information indicating that “the article B is to be removed from the container P”.

In the case of the [Inappropriate work 3], the inappropriate-work information includes keeping-failure work information indicating that “there is a failure in keeping the article A in the container P” and erroneous-keeping work information indicating that “the article B is erroneously kept in the container Q”. Further, the inappropriate-work correction information includes keeping-failure correction information indicating that “the article A is to be put into the container P” and erroneous-keeping correction information indicating that “the article B is to be removed from the container Q”.

In the embodiment, the type flag for the inappropriate-work information is set to “0”. Therefore, the type flag for the inappropriate-work correction information is set to “1”.

The erroneous-keeping information is erroneous-keeping work information or erroneous-keeping correction information. That is, in the case where the type flag is “0”, the erroneous-keeping information is erroneous-keeping work information. In the case where the type flag is “1”, the erroneous-keeping information is erroneous-keeping correction information.

The keeping-failure information is keeping-failure work information or keeping-failure correction information. That is, in the case where the type flag is “0”, the keeping-failure information is keeping-failure work information. In the case where the type flag is “1”, the keeping-failure information is keeping-failure correction information.

The communication circuit 34 shown in FIG. 9 is a circuit for performing data communication with the management server 10 connected by the communication network 50 (see FIG. 1).

The article instruction circuit 35 shown in FIG. 9 is a circuit for selectively operating the display unit 72 attached to the article box 71 in order to instruct the worker M in the work zone 300 to take out the article.

The container instruction circuit 36 shown in FIG. 9 is a circuit for selectively operating the display unit 61 attached to the container 60 in order to notify the worker M in the work zone 300 of the container 60 of the article putting destination.

The termination switch 37 shown in FIG. 9 is an operator operated by the worker M every time the picking work is finished in response to one work instruction. The type of the termination switch 37 is not particularly limited. For example, the termination switch 37 may be a push-button switch, a toggle switch, or the like.

The behavior monitoring camera 38 shown in FIG. 9 is a camera for monitoring the behavior of the worker M in the work zone 300. The behavior monitoring camera 38 is attached to a position where the behavior of the worker M taking out an article from the article box 71 and putting the article into the container 60 can be imaged. As the behavior monitoring camera 38, for example, a well-known camera sensor such as an optical camera, an infra-red camera, a TOF (Time of Flight) camera, and a stereoscopic camera can be used.

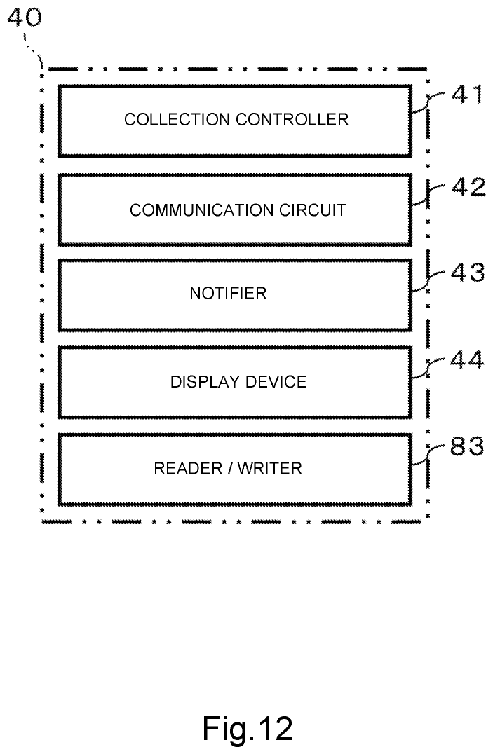

FIG. 12 is a block diagram showing a configuration of the collection zone facility 40. The collection zone facility 40 includes a collection controller 41, a communication circuit 42, a notifier 43, a display device 44, and the above-mentioned reader/writer 83.

The collection controller 41 shown in FIG. 12 realizes the function as the collection zone facility 40 by controlling the respective units in accordance with the control program. The collection controller 41 mainly includes a processor and a main memory as in the work controller 31. The processor is, for example, a CPU. The main memory is, for example, a ROM and a RAM.

The communication circuit 42 shown in FIG. 12 is a circuit for performing data communication with the management server 10 connected by the communication network 50(see FIG. 1).

The notifier 43 shown in FIG. 12 performs a notifying operation when the container 60 to be collected needs correction work. The notifier 43 is, for example, a buzzer. The notifier 43 may be a lamp, a diaphragm, or the like. The notifier 43 may be a combination of a buzzer, a lamp, a diaphragm, and the like.

The display device 44 shown in FIG. 12 is a device for displaying inappropriate-work information and inappropriate-work correction information for the container 60 that needs correction work.

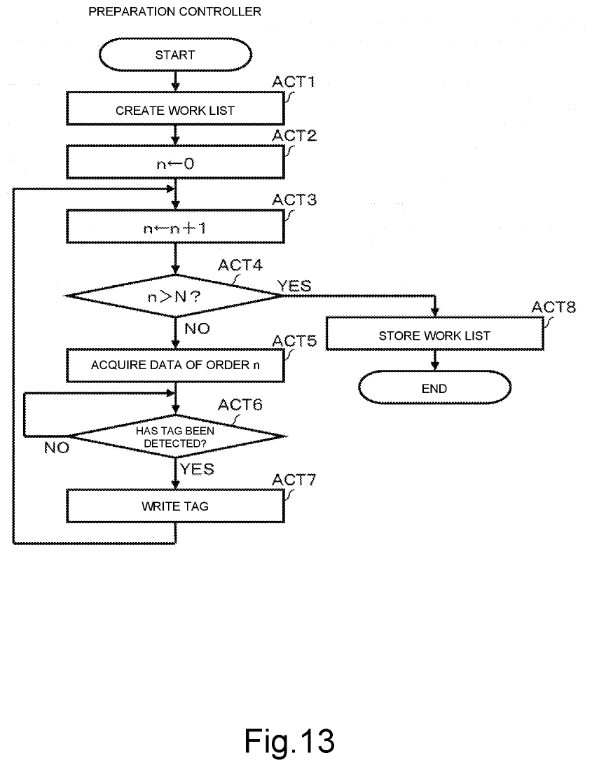

Next, information processing of the logistics base system 100 will be described with reference to the flowcharts of FIG. 13 to FIG. 16. Note that the information processing described below is an example. The procedure and the like of the information processing are not particularly limited as long as similar results can be achieved.

First, the operation information processing of the preparation zone facility 20 will be described mainly with regard to the preparation controller 21. FIG. 13 is a flowchart showing information processing of the preparation controller 21. The preparation controller 21 creates the work list 221 in ACT1. That is, the preparation controller 21 accesses the management server 10 via the communication circuit 23 and acquires the voucher record 121 from the voucher database 12. The preparation controller 21 selects a voucher to be worked on today from the voucher information of the voucher record 121. For example, the preparation controller 21 selects a voucher having a delivery date of the next day as a voucher to be worked. Alternatively, the preparation controller 21 selects a voucher for which a predetermined number of days have elapsed from the order date as a voucher to be worked. The preparation controller 21 registers the voucher number and the article list of the selected voucher in the work list 221 (see FIG. 8) in the order of the work order. In this way, the work list 221 is created.

When the preparation controller 21 finishes creating the work list 221, the preparation controller 21 resets a count value n of the counter to “0” in ACT2. The preparation controller 21 then increments the count value n by “1” in ACT3. Then, in ACT4, the preparation controller 21 determines whether or not the count value n exceeds the maximum value N of the work order in the work list 221.

In the case where it is determined that the count value n does not exceed the maximum value N (NO in ACT4), the processing of the preparation controller 21 proceeds to ACT5. In ACT5, the preparation controller 21 acquires the voucher number and the article list registered in the work list 221 in association with the work order corresponding to the count value n. Then, in ACT6, the preparation controller 21 stands by until the reader/writer 81 detects the RFID tag 612 by determining whether or not the reader/writer 81 has initiated communication with the RFID tag 612.

When the display unit 61 of the container 60 conveyed by the conveyor 500 faces the reader/writer 81 in this condition, the reader/writer 81 communicates with the RFID tag 612 attached to the display unit 61. When it is determined that the reader/writer 81 has initiated communication with the RFID tag 612 (YES in ACT6), the processing of the preparation controller 21 proceeds to ACT7. In ACT7, the preparation controller 21 controls the reader/writer 81 to write the acquired voucher number and the acquired article list (see ACT5) described above to the RFID tag 612. By such control, the voucher number and the article list are written to the RFID tag 612 attached to the display unit 61 facing the reader/writer 81.

When the preparation controller 21 finishes the processing of ACTT, the processing of the preparation controller 21 returns to the processing of ACT3. The preparation controller 21 then executes the processing of ACT3 and subsequent ACTs in the way as described above. As a result, the voucher number and the article list registered in the work list 221 are sequentially written to the RFID tag 612 attached to the display unit 61 of the container 60 conveyed to the position of the reader/writer 81. When it is determined that the voucher number and the article list corresponding to the maximum value N of the work order have been written to the RFID tag 612 (YES in ACT4), the processing of the preparation controller 21 proceeds to ACT8. The preparation controller 21 stores the work list 221 in ACT8. Thus, the preparation controller 21 finishes the information processing shown in the flowchart of FIG. 13.

As described above, in the preparation zone facility 20, the voucher number and the article list are sequentially assigned to the containers 60 sequentially conveyed by the conveyor 500. Then, the voucher number and the article list are written to the RFID tag 612 attached to the display unit 61 of the container 60. The container 60 is conveyed to the work zone 300 of the subsequent stage integrally with the RFID tag 612 to which the voucher number and the article list have been written.

Next, the information processing of the work zone facility 30 will be described mainly with regard to the work controller 31. Note that the information processing executed in the plurality of work zone facilities 30 is the same. For this reason, information processing of one work zone facility 30 will be described below.

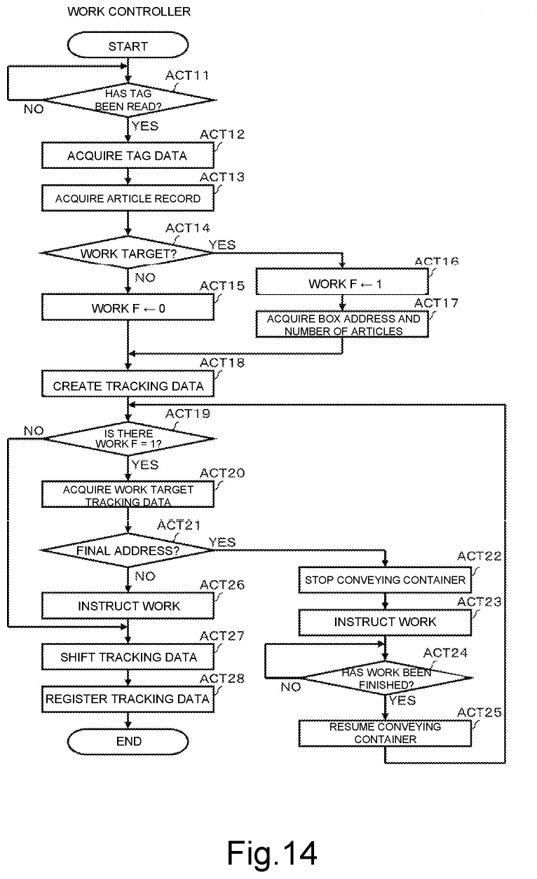

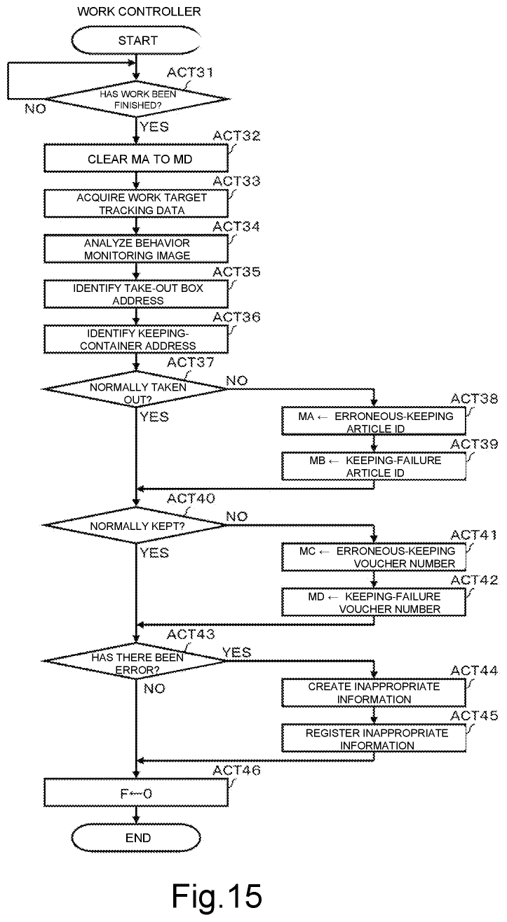

FIG. 14 and FIG. 15 are each a flowchart showing the information processing of the work controller 31. The work controller 31 executes information processing shown in the flowchart of FIG. 14 and information processing shown in the flowchart of FIG. 15 in parallel. First, the information processing of FIG. 14 will be described.

In ACT11 shown in FIG. 14, the work controller 31 stands by until receiving the data of the RFID tag 612 by determining whether or not the reader/writer 82 has initiated communication with the RFID tag 612 and has read the data from the RFID tag 612. When the container 60 conveyed by the conveyor 500 is conveyed to the work zone 300 and the display unit 61 of the container 60 faces the reader/writer 82 in this condition, the reader/writer 82 communicates with the RFID tag 612 provided in the display unit 61. The reader/writer 82 then reads the data from the RFID tag 612. The data includes the voucher number and the article list written by the reader/writer 81 of the preparation zone facility 20.

When it is determined that the reader/writer 82 has read the RFID tag 612 (YES in ACT11), the processing of the work controller 31 proceeds to ACT12. The work controller 31 acquires the voucher number and the article list from the data of the RFID tag 612 in ACT12.

The work controller 31 acquires the article record 111 (see FIG. 5) of each of the article IDs included in the article list in ACT13. That is, the work controller 31 transmits a request command of the article record 111 to the management server 10. The request command includes all article IDs in the article list. The management server 10 searches the article database 11 by the respective article IDs included in the request command. The management server 10 then reads the article record 111 including the article ID from the article database 11. The management server 10 transmits the article record 111 read from the article database 11 to the work zone facility 30 of the transmission source of the request command. In this way, the work controller 31 acquires the article record 111 of each of the article IDs included in the article list.

When the work controller 31 finishes acquiring the article record 111, the work controller 31 determines whether or not the work zone 300 provided with the work zone facility 30 including the work controller is a work target in ACT14. Specifically, in the case where the work controller 31 acquires the article record 111 in which the work zone number of the work zone facility 30 including the work controller 31 is set, the work controller 31 determines that the work zone 300 provided with the work zone facility 30 including the work controller 31 is the working target. In the case where the work controller 31 does not acquire the article record 111 in which the work zone number of the work zone facility including the work controller 31 is set, the work controller 31 determines that the work zone 300 provided with the work zone facility 30 including the work controller 31 is not a work target. Hereinafter, the article record 111 in which the work zone number of the work zone facility 30 including the work controller 31 is set will be referred to as the work article record.

In the case where it is determined that the work zone 300 provided with the work zone facility 30 including the work controller 31 is not a work target (NO in ACT14), the processing of the work controller 31 proceeds to ACT15. The work controller 31 sets the work flag F to “0” in ACT15. The processing of the work controller 31 then proceeds to ACT18.

Meanwhile, in the case where it is determined that the work zone 300 provided with the work zone facility 30 including the work controller 31 is a work target (YES in ACT14), the processing of the work controller 31 proceeds to ACT16. The work controller 31 sets the work flag F to “1” in ACT16. Further, the work controller 31 acquires the box address and the number of articles in ACT17. That is, the work controller 31 acquires the box address from the work article record. Further, the work controller 31 acquires the number of articles registered in the article list in association with the article ID of the work article record. After that, the processing of the work controller 31 proceeds to ACT18.

The work controller 31 creates tracking data in ACT18. That is, in the case where the work zone 300 is not a work target, the work controller 31 creates the tracking data from the voucher number and the work flag F. The voucher number is the data read from the RFID tag 612. The work flag F is “0”. The box address and the number of articles are each a NULL value.

Meanwhile, in the case where the work zone 300 is a work target, the work controller 31 creates the tracking data from the voucher number, the work flag F, the box address, and the number of articles. The voucher number is the data read from the RFID tag 612. The work flag F is “1”. The box address is acquired from the work article record. The number of articles is acquired from the article list.

In ACT19, the work controller 31 searches the tracking list 321 to determine whether or not there is tracking data with the working flag F set to “1”. In the case where it is determined that there is no tracking data with the work flag F set to “1” in the tracking list 321 (NO in ACT19), the processing of the work controller 31 proceeds to ACT27. In ACT27, the work controller 31 shifts the tracking data registered in the tracking list 321 one by one in the direction in which the container address increases. The work controller 31 registers the tracking data created in the processing of ACT18 in the tracking list 321 in association with the smallest container address “1” in ACT28. In this way, the tracking data is stored in the tracking storage device 32. Note that the tracking data of the final address (“5” in FIG. 10) is deleted from the tracking list 321 by shifting. Thus, the work controller 31 finishes the information processing shown in the flowchart of FIG. 14.

Meanwhile, in the case where it is determined that the tracking data with the work flag F set to “1” is registered in the tracking list 321 (YES in ACT19), the processing of the work controller 31 proceeds to ACT20. The work controller 31 searches the tracking list 321 from the larger container address in ACT20 and acquires the tracking data with the work flag F set to “1”. Hereinafter, the acquired QR code will be referred to as the work target tracking data.

In ACT21, the work controller 31 determines whether or not the container address of the work target tracking data is the final address. In the case where it is determined that the container address of the work target tracking data is the final address, the container 60, which is conveyed integrally with the RFID tag 612 to which the voucher number of the work target tracking data has been written, is located on the end side of the work zone 300.

In the case where it is determined that the container address of the work target tracking data is the final address (YES in ACT21), the processing of the work controller 31 proceeds to ACT22. The work controller 31 stops conveying the container by the conveyor 500 in ACT22. Then, in ACT23, the work controller 31 controls the article instruction circuit 35 and the container instruction circuit 36 on the basis of the work target tracking data, and instructs to perform the picking work. Specifically, the work controller 31 turns on the lamp 721 of the display unit 72 provided in the article box 71 located at the position specified by the box address of the work target tracking data, and displays the number of pieces of the work target tracking data on the numerical-value indicator 722 of the display unit 72. This indicates the place where the article to be taken out has been kept. Further, the work controller 31 turns on the lamp 611 of the display unit 61 provided in the container 60 located at the position specified by the container address of the work target tracking data. As a result, the container 60 of the sorting destination in which the article is to be kept is indicated.

Therefore, the worker M performs picking work of taking out an article(s) from the article box 71 on which the lamp 721 has been lit and putting the article(s) into the container 60 on which the lamp 611 has been lit, the number of articles to be taken out being the number displayed on the numerical-value indicator 722. After completing the work, the worker M operates the termination switch 37.

The work controller 31 stands by until the termination switch 37 is operated in ACT24 by determining whether or not the termination switch 37 has been operated. In the case where it is determined that the termination switch 37 has been operated (YES in ACT24), the processing of the work controller 31 proceeds to ACT25. The work controller 31 causes the conveyor 500 to resume conveying the container 60 in ACT25. The processing of the work controller 31 then returns to ACT19.

Here, in the case where other tracking data with the work flag set to “1” is not registered in the tracking list 321, the work controller 31 executes the processing of ACT27 and ACT28 in the way as described above, and finishes the information processing shown in the flowchart of FIG. 14.

Meanwhile, in the case where there is tracking data with the work flag set to “1” in pieces of tracking data associated with container addresses other than the final address, the work controller 31 acquires the work target tracking data in ACT20. In the case where it is determined that the container address of the work target tracking data is not the final address (NO in ACT21), the processing of the work controller 31 proceeds to ACT26. In ACT26, the work controller 31 controls the article instruction circuit 35 and the container instruction circuit 36 in the same manner as the processing of ACT23, and instructs to perform the picking work. After that, the work controller 31 executes the processing of ACT27 and ACT28 in the way as described above, and finishes the information processing shown in the flowchart of FIG. 14. After that, the work controller 31 repeatedly executes the processing of ACT12 to ACT28 every time the data of the RFID tag 612 corresponding to the next container 60 is read by the reader/writer 83.

Next, the information processing of FIG. 15 will be described. The work controller 31 stands by until the termination switch 37 is operated in ACT31 by determining whether or not the termination switch 37 has been operated. In the case where it is determined that the termination switch 37 has been operated (Yes in ACT31), the processing of the work controller 31 proceeds to ACT32. Therefore, also in the case where it is determined that the termination switch 37 has been operated in ACT24 of FIG. 14, the work controller 31 executes the processing of ACT32 and subsequent ACTs of FIG. 15 in parallel with the processing of FIG. 14.

The work controller 31 clears the work memory MA, the work memory MB, the work memory MC, and the work memory MD of the main memory 31b in ACT32. The work controller 31 then searches the tracking list 321 to acquire the work target tracking data in ACT33. Further, the work controller 31 analyzes the behavior monitoring image captured by the behavior monitoring camera 38 during the necessary work time until the termination switch 37 is operated in ACT34. The necessary work time represents the time that is sufficient for the worker M to finish the picking work after the work instruction is issued. The necessary work time is, for example, 10 seconds.

In ACT35, the work controller 31 identifies, from the behavior monitoring image, the box address of the article box 71 from which the worker M has taken out the article. That is, the area to be imaged by the behavior monitoring camera 38 is fixed. Further, the position of the article box 71 disposed on the article shelf 70 is also fixed. Therefore, when the hand of the worker M who works on the article box 71 is detected from the image of the article shelf 70 captured by the behavior monitoring camera 38, it is possible to recognize, from the position of the hand, which position of the article shelf 70 the article box 71 on which the work has been performed is located. The work controller 31 identifies the box address from the position of the article box 71 on which the work has been performed. Hereinafter, the box address identified in the processing of ACT35 process will be referred to as the take-out box address.

In ACT36, the work controller 31 identifies, from the behavior monitoring image, the container address of the container 60 into which the worker M has put the article. That is, the area to be imaged by the behavior monitoring camera 38 is fixed. Further, the order of the container 60 conveyed by the conveyor 500 is random. Therefore, when the hand of the worker M who works on the container 60 is detected from the image of the conveyor 500 captured by the behavior monitoring camera 38, it is possible to recognize, from the position of the hand, on which container 60 on the conveyor 500 the work has been performed. The work controller 31 identifies the container address from the position of the container 60 on which the work has been performed. Hereinafter, the container address identified in the processing of ACT36 will be referred to as the keeping-container address.

In ACT37, the work controller 31 determines whether or not the work of taking out the article has been normally performed. That is, the work controller 31 determines whether or not the take-out box address identified in the processing of ACT35 coincides with the box address of the work target tracking data acquired in the processing of ACT33. In the case where it is determined that the identified take-out box address described above coincides with the box address of the acquired work target tracking data described above, the work controller 31 determines that the work of removing the article has been normally performed. In the case where it is determined that the identified take-out box address described above does not coincide with the box address of the acquired work target tracking data described above, the work controller 31 determines that the work of taking out the article has not been normally performed.

In the case where it is determined that the work of taking out the article has been normally performed (YES in ACT37), the processing of the work controller 31 proceeds to ACT40.

In the case where it is determined that the work of taking out the article has not been normally performed (NO in ACT37), the processing of the work controller 31 proceeds to ACT38. In ACT 38, the work controller 31 acquires the article ID of the article record 111 that includes the work zone number of the work zone 300 including the work controller 31, and the take-out box address. Then, the work controller 31 stores the article ID in the work memory MA as an erroneous-keeping article ID. Further, in ACT39, the work controller 31 acquires the article ID of the article record 111 that includes the work zone number of the work zone 300 including the work controller 31, and the box address of the work target tracking data. Then, the work controller 31 stores the article ID in the work memory MB as a keeping-failure article ID. After that, the processing of the work controller 31 proceeds to ACT40.

The work controller 31 determines whether or not the work of keeping the article has been normally performed in ACT40. That is, the work controller 31 determines whether or not the keeping-container address identified in the processing of ACT36 coincides with the container address of the work target tracking data acquired in the processing of ACT33. In the case where it is determined that the identified keeping-container address described above coincides with the container address of the acquired work target tracking data described above, the work controller 31 determines that the work of keeping the article has been normally performed. In the case where it is determined that the identified keeping-container address described above does not coincide with the container address of the acquired work target tracking data described above, the work controller 31 recognizes that the work of keeping the article has not been normally performed.

In the case where it is determined that the work of keeping the article has been normally performed (YES in ACT40), the processing of the work controller 31 proceeds to ACT43.

In the case where it is determined that the work of keeping the article has not been normally performed (NO in ACT40), the processing of the work controller 31 proceeds to ACT41. In ACT41, the work controller 31 acquires the voucher number registered in the tracking list 321 in association with the keeping-container address. Then, the work controller 31 stores the voucher number in the work memory MC as the erroneous-keeping voucher number. Further, the work controller 31 acquires the voucher number of the work target tracking data in ACT42. Then, the work controller 31 stores the voucher number in the work memory MD as the keeping-failure voucher number. After that, the processing of the work controller 31 proceeds to ACT43.

The work controller 31 determines whether or not there has been an error in the picking work in ACT43. In the case where no data is stored in the work memory MA, the work memory MB, the work memory MC, and the work memory MD, the work controller 31 determines that the picking work has been normally performed (NO in ACT43). The processing of the work controller 31 then proceeds to ACT46.

In the case where data is stored in the work memory MA and the work memory MB, or in the work memory MC and the work memory MD, or data is stored in the work memory MA, the work memory MB, the work memory MC, and the work memory MD, the work controller 31 determines that there has been an error in the picking work (YES in ACT43). The processing of the work controller 31 then proceeds to ACT44. The work controller 31 creates inappropriate information in ACT44.

Specifically, in the case where data is not stored in the work memory MA and the work memory MB and data is stored in the work memory MC and the work memory MD, the work controller 31 determines that the above-mentioned [Inappropriate work 1] has been performed.

In this case, the work controller 31 creates keeping-failure work information 901 indicating that “there is a keeping-failure of the article kept in the article box 71 identified by the box address of the work target tracking data for the container 60 in which the keeping-failure voucher number stored in the work memory MD is stored in the RFID tag 612”. Further, the work controller 31 creates erroneous-keeping work information 902 indicating that “the article stored in the article box 71 identified by the box address of the work target tracking data is erroneously kept in the container 60 in which the erroneous-keeping voucher number stored in the work memory MC is stored in the RFID tag 612”.

Further, the work controller 31 creates keeping-failure correction information 903 indicating that “the article kept in the article box 71 identified by the box address of the work target tracking data is to be kept in the container 60 in which the keeping-failure voucher number stored in the work memory MD is stored in the RFID tag 612”. Further, the work controller 31 creates erroneous-keeping correction information 904 indicating that “the article kept in the article box 71 identified by the box address of the work target tracking data is to be removed from the container 60 in which the erroneous-keeping voucher number stored in the work memory MC is stored in the RFID tag 612”.

In the case where data is not stored in the work memory MC and the work memory MD and data is stored in the work memory MA and the work memory MB, the work controller 31 determines that the above-mentioned [Inappropriate work 2] has been performed. In this case, the work controller 31 creates keeping-failure work information 905 indicating that “there is a keeping-failure of the article having the keeping-failure article ID stored in the work memory MB for the container 60 in which the voucher number of the work target tracking data is stored in the RFID tag 612”. Further, the work controller 31 creates erroneous-keeping work information 906 indicating that “the article identified by the erroneous-keeping article ID stored in the work memory MA is erroneously kept in the container 60 in which the voucher number of the work target tracking data is stored in the RFID tag 612”.

Further, the work controller 31 creates keeping-failure correction information 907 indicating that “the article of the keeping-failure article ID stored in the work memory MB is to be kept in the container 60 in which the voucher number of the work target tracking data is stored in the RFID tag 612”. Further, the work controller 31 creates erroneous-keeping correction information 908 indicating that “the article identified by the erroneous-keeping article ID stored in the work memory MA is to be removed from the container 60 in which the voucher number of the work target tracking data is stored in the RFID tag 612”.

In the case where data is stored in all of the work memory MA, the work memory MB, the work memory MC, and the work memory MD, the work controller 31 determines that the above-mentioned [Inappropriate work 3] has been performed.

In this case, the work controller 31 creates keeping-failure work information 909 indicating that “there is a keeping-failure of the article having the keeping-failure article ID stored in the work memory MB for the container 60 in which the keeping-failure voucher number stored in the work memory MD is stored in the RFID tag 612”. Further, the work controller 31 creates erroneous-keeping work information 910 indicating that “the article having the erroneous-keeping article ID stored in the work memory MA is kept in the container 60 in which the erroneous-keeping voucher number stored in the work memory MC is stored in the RFID tag 612”.

Further, the work controller 31 creates keeping-failure correction information 911 indicating that “the article having the keeping-failure article ID stored in the work memory MB is to be kept in the container 60 in which the keeping-failure voucher number stored in the work memory MD is stored in the RFID tag 612”. Further, the work controller creates erroneous-keeping correction information 912 indicating that “the article of the erroneous-keeping article ID stored in the work memory MA is to be removed from the container 60 in which the keeping-failure voucher number stored in the work memory MC is stored in the RFID tag 612”.

When the work controller 31 finishes creating the inappropriate information, the processing of the work controller 31 proceeds to ACT45. The work controller 31 registers the inappropriate information in the inappropriate-information list 331 in ACT45.

Specifically, in the case where the work controller 31 has created the keeping-failure work information 901, the work controller 31 registers the keeping-failure work information 901 in the inappropriate-information list 331 (see FIG. 11) together with the keeping-failure voucher number stored in the work memory MD and the type flag of “0”.

In the case where the work controller 31 has created the erroneous-keeping work information 902, the work controller 31 registers the erroneous-keeping work information 902 in the inappropriate-information list 331 together with the erroneous-keeping voucher number stored in the work memory MC and the type flag of “0”.

In the case where the work controller 31 has created the keeping-failure correction information 903, the work controller 31 registers the keeping-failure correction information 903 in the inappropriate-information list 331 together with the keeping-failure voucher number stored in the work memory MD and the type flag of “1”.

In the case where the work controller 31 has created the erroneous-keeping correction information 904, the work controller 31 registers the erroneous-keeping correction information 904 in the inappropriate-information list 331 together with the erroneous-keeping voucher number stored in the work memory MC and the type flag of “1”.

In the case where the work controller 31 has created the keeping-failure work information 905, the work controller 31 registers the keeping-failure work information 905 in the inappropriate-information list 331 together with the voucher number of the work target tracking data and the type flag of “0”.

In the case where the work controller 31 has created the erroneous-keeping work information 906, the work controller 31 registers the erroneous-keeping work information 906 in the inappropriate-information list 331 together with the voucher number stored in the tracking list 321 in association with the keeping-container address identified in the processing of ACT36 and the type flag of “0”.

In the case where the work controller 31 has created the keeping-failure correction information 907, the work controller 31 registers the keeping-failure correction information 907 in the inappropriate-information list 331 together with the voucher number of the work target tracking data and the type flag of “1”.

In the case where the work controller 31 has created the erroneous-keeping correction information 908, the work controller 31 registers the erroneous-keeping correction information 908 in the inappropriate-information list 331 together with the voucher number stored in the tracking list 321 in association with the keeping-container address identified in the processing of ACT36 and the type flag of “1”.

In the case where the work controller 31 has created the keeping-failure work information 909, the work controller 31 registers the keeping-failure work information 909 in the inappropriate-information list 331 together with the voucher number of the work target tracking data and the type flag of “0”.

In the case where the work controller 31 has created the erroneous-keeping work information 910, the work controller 31 registers the erroneous-keeping work information 910 in the inappropriate-information list 331 together with the voucher number stored in the tracking list 321 in association with the keeping-container address identified in the processing of ACT36 and the type flag of “0”.

In the case where the work controller 31 has created the erroneous-keeping correction information 911, the work controller 31 registers the keeping-failure correction information 911 in the inappropriate-information list 331 together with the voucher number of the work target tracking data and the type flag of “1”.

In the case where the work controller 31 has created the erroneous-keeping correction information 912, the work controller 31 registers the erroneous-keeping correction information 912 in the inappropriate-information list 331 together with the voucher number stored in the tracking list 321 in association with the keeping-container address identified in the processing of ACT36 and the type flag of “1”.

When the work controller 31 finishes registering the inappropriate information, the processing of the work controller 31 proceeds to ACT46. The work controller 31 changes the work flag of the work target tracking data registered in the tracking list 321 from “1” to “0” in ACT46. Thus, the work controller 31 finishes the processing shown in the flowchart of FIG. 15. After that, the work controller 31 repeatedly executes the processing of ACT32 to ACT46 every time the termination switch 37 is operated.

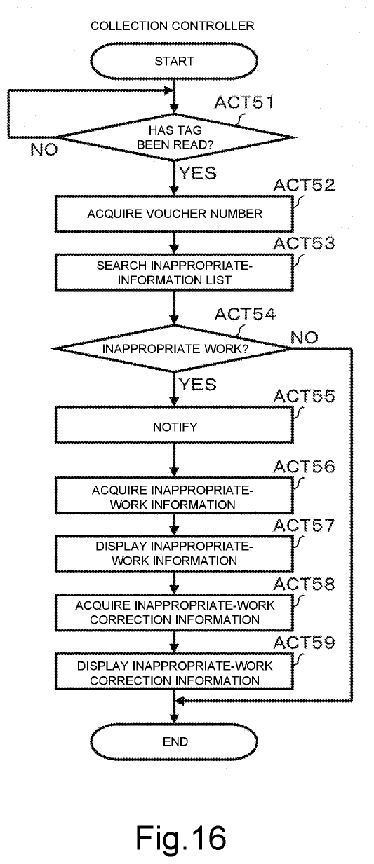

Next, the information processing of the collection zone facility 40 will be described mainly with regard to the collection controller 41. FIG. 16 is a flowchart showing the information processing of the collection controller 41. The collection controller 41 stands by until receiving the data of the RFID tag 612 in ACT51 by determining whether or not the reader/writer 83 has initiated communication with the RFID tag 612 and has read the data from the RFID tag 612. When the container 60 conveyed by the conveyor 500 is conveyed to the collection zone 400 and the display unit 61 of the container 60 faces the reader/writer 83 in this condition, the reader/writer 83 communicates with the RFID tag 612 provided in the display unit 61. The reader/writer then reads the data from the RFID tag 612. The data includes a voucher number.

When it is determined that the reader/writer 83 has read the data of the RFID tag 612 (YES in ACT51), the processing of the collection controller 41 proceeds to ACT52. The collection controller 41 acquires the voucher number from the data of the RFID tag 612 in ACT52.

The collection controller 41 searches the inappropriate-information list 331 in ACT53. Then, in ACT54, the collection controller 41 determines whether or not the inappropriate information including the voucher number acquired from the RFID tag 612 is registered in the inappropriate-information list 331. In the case where it is determined that the inappropriate information of the voucher number is not registered (NO in ACT54), the collection controller 41 finishes the processing shown in the flowchart of FIG. 16.

In the case where it is determined that the inappropriate information including the voucher number acquired from the RFID tag 612 is registered in the inappropriate-information list 331 (YES in ACT54), the processing of the collection controller 41 proceeds to ACT55. The collection controller 41 operates the notifier 43 in ACT55. As a result, in the case where the notifier 43 is a buzzer, the buzzer sounds. In the case where the notifier 43 is a lamp, the lamp lights or blinks. In the case where the notifier 43 is a diaphragm, the diaphragm vibrates. By the operation of the notifier 43, the collection worker in charge of the collection work can know that inappropriate work has been performed on the container 60 conveyed to the collection zone 400 in the work zone 300.

In ACT56, the collection controller 41 acquires information with the type flag set to “0”, i.e., inappropriate-work information, from pieces of inappropriate information including the voucher number acquired from the RFID tag 612. The collection controller 41 then displays the inappropriate work information on the display 44 in ACT57. Therefore, in the case where the inappropriate work is erroneous-keeping, the erroneous-keeping work information is displayed on the display device 44. As a result, the collection worker can know that erroneous-keeping has been performed on the container 60 conveyed to the collection zone 400. Similarly, in the case where the inappropriate work is keeping-failure, the keeping-failure work information is displayed on the display device 44. As a result, the collection worker can know that there has been the keeping-failure in the container 60 conveyed to the collection zone 400.

In ACT58, the collection controller 41 acquires information with the type flag set to “1”, i.e., inappropriate-work correction information, from pieces of inappropriate information including the voucher number acquired from the RFID tag 612. The collection controller 41 then displays the inappropriate-work correction information on the display 44 in ACT59. Therefore, in the case where the inappropriate work is erroneous-keeping, the erroneous-keeping correction information is displayed on the display device 44. As a result, the collection worker can identify and remove the erroneously kept article from the container 60 conveyed to the collection zone 400. Similarly, in the case where the inappropriate work is keeping-failure, the keeping-failure correction information is displayed on the display device 44. As a result, the collection worker can identify the article that has been failed to be kept and put the identified article into the container 60 conveyed to the collection zone 400.

After completing the above-mentioned processing, the collection controller 41 finishes the information processing shown in the flowchart of FIG. 16. After that, the collection controller 41 repeatedly executes the processing of ACT52 to ACT59 every time the data of the RFID tag 612 corresponding to the next container 60 is read by the reader/writer 83.

Here, the work zone facility 30 and the collection zone facility 40 realize the function as the work monitoring system 101. That is, the work controller 31 of the work zone facility 30 cooperates with the behavior monitoring camera 38 to constitute a monitoring unit. Further, the work controller 31 cooperates with the tracking storage device 32 to constitute an identifying unit. Further, the work controller 31 cooperates with the inappropriate-information storage device 33 to constitute a storage unit. Further, the work controller 31 constitutes a creation unit.

The collection controller 41 of the collection zone facility 40 cooperates with the reader/writer 83 to constitute a detection unit. Further, the collection controller 41 cooperates with the notifier 43 to constitute a notifying unit. Further, the collection controller 41 cooperates with the display device 44 to constitute a notification unit.

As a result, when the container P in which the keeping-failure has occurred due to the above-mentioned [Inappropriate work 1] is conveyed to the collection zone 400, the notifier 43 is activated. Then, the keeping-failure work information 901 and the keeping-failure correction information 903 are displayed on the display device 44. Therefore, the collection worker only needs to put the article A into the container P.

Further, also in the case where the container Q in which the erroneous-keeping has occurred due to the above-mentioned [Inappropriate work 1] is conveyed to the collection zone 400, the notifier 43 is activated. Then, the erroneous-keeping work information 902 and the erroneous-keeping correction information 904 are displayed on the display device 44. Therefore, the collection worker only needs to remove the article A from the container Q.

Further, also in the case where the container P in which the erroneous-keeping and the keeping-failure have occurred due to the above-mentioned [Inappropriate work 2] is conveyed to the collection zone 400, the notifier 43 is activated. Then, the keeping-failure work information 905, the erroneous-keeping work information 906, the keeping-failure correction information 907, and the erroneous-keeping correction information 908 are displayed on the display device 44. Therefore, the collection worker only needs to remove the article B from the container P and put the article A into the container P.

Further, also in the case where the container P in which the keeping-failure has occurred due to the above-mentioned [Inappropriate work 3] is conveyed to the collection zone 400, the notifier 43 is activated. Then, the keeping-failure work information 909 and the keeping-failure correction information 911 are displayed on the display device 44. Therefore, the collection worker only needs to put the article A into the container P.

Further, also in the case where the container Q in which the erroneous-keeping has occurred due to the above-mentioned [Inappropriate work 3] is conveyed to the collection zone 400, the notifier 43 is activated. Then, the erroneous-keeping work information 910 and the erroneous-keeping correction information 912 are displayed on the display device 44. Therefore, the collection worker only needs to remove the article B from the container Q.

As described above in detail, in accordance with the work monitoring system 101 according to the embodiment, in the case where inappropriate work is performed in the work zone 300 in response to a work instruction, the work can be monitored so that the work can be returned to an appropriate condition in the collection zone 400. Therefore, the mistake in the picking work can be corrected without stopping the flow of the picking work performed in the logistics base system 100.

Moreover, since the inappropriate-work information indicating the content of the inappropriate work is displayed on the display device 44, the collection worker can easily know the content of the inappropriate work. In addition, since the inappropriate-work correction information for correcting the inappropriate work is also displayed on the display device 44, the collection worker can easily know how to correct the inappropriate work.

Although the work monitoring system 101 according to the embodiment has been described, such an embodiment is not limited thereto.

For example, in the above-mentioned embodiment, the function as the work monitoring system 101 is realized by the work zone facility 30 and the collection zone facility 40. In another embodiment, the management server 10 may realize the function as a work monitoring system.

In the above-mentioned embodiment, the work monitoring system 101 that monitors the picking work in the logistics base in which the article shelf 70 is located at the position facing the worker M with the conveyor 500 interposed therebetween has been exemplified. In this respect, the work monitoring system 101 according to the embodiment can be similarly applied to the case where the picking work of the logistics base in which the article shelf 70 is located at the position facing the conveyor 500 with the worker M interposed therebetween is monitored. Further, the work to be monitored is not limited to the picking work.

Further, the correction zone needs not necessarily be the collection zone 400. A correction zone may be provided between the work zone 300 of the last stage and the collection zone 400 to notify that the container 60 on which inappropriate work has been performed has been conveyed to the correction zone, and the inappropriate-work information and the inappropriate correction information may be displayed on the display device.

The device of the monitoring unit is not limited to the behavior monitoring camera 38. For example, the behavior of the worker M may be monitored by a sensor that follows the movement of the hand of the worker M.

In the above-mentioned embodiment, the collection zone facility 40 is provided with the notifier 43. In another embodiment, the lamp 611 of the display unit 61 attached to the container 60 may be operated as a notifier. That is, when the container 60 on which inappropriate work has been performed is conveyed to the collection zone 400, the lamp 611 of the container 60 is lighted or blinked to notify the collection worker of the fact. With such a configuration, the notifier 43 can be omitted.

In the above-mentioned embodiment, a case where the work instruction is performed by using, as a trigger, the reading of the data of the RFID tag 612 by the reader/writer 82 provided in the work zone 300 has been described. The timing at which the work instruction is performed is not limited thereto. For example, the conveyance quantity of the container 60 conveyed by the conveyor 500 may be monitored, and a work instruction may be issued if it is recognized that the container 60 has reached the work zone 300 to be worked. In this case, the reader/writer 82 can be omitted.

In the above-mentioned embodiment, the RFID tag 612 is provided in the display unit 61 corresponding to the container 60, and the voucher number is recorded on this RFID tag 612 as container-identifying information. The medium for recording the voucher number is not limited to the RFID tag 612. Further, the container-identifying information is not limited to the voucher number. A paper label on which container-identifying information unique to the container 60 is printed may be attached to the container and the container-identifying information of the paper label may be read by an optical character reader (OCR) instead of the reader/writers 81 to 83.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A work monitoring system that monitors work of a worker on a work target conveyed from a work zone where the work is performed in accordance with a predetermined work instruction to a correction zone where the work is corrected, comprising:
a monitoring camera that captures an image of a behavior of the worker on the work target;
a first storage device that stores tracking data including content of the work instruction for the worker in association with the work target to track the behavior of the worker;
a detector that detects the work target conveyed to the correction zone;
a notifier that notifies that inappropriate work different from work designated by the work instruction has been performed on the work target; and
a controller that
monitors the work of the worker in the work zone on the basis of the image captured by the monitoring camera,
determines whether or not the inappropriate work on the work target has been performed by the worker on the basis of a result of monitoring the work and the tracking data stored in the first storage device,
identifies, where it is determined that the inappropriate work on the work target has been performed, the work target on which the inappropriate work has been performed, on the basis of the result, and
operates, where it is determined that the identified work target has been conveyed to the correction zone, the notifier on the basis of a detection result of the detector.

2. The work monitoring system according to claim 1, further comprising
a second storage device that stores inappropriate-work information indicating content of inappropriate work performed on the work target in association with the identified work target, wherein
the controller stores, where it is determined that the inappropriate work on the work target has been performed, the inappropriate-work information indicating the content of the inappropriate work performed on the work target in the second storage device in association with the identified work target.

3. The work monitoring system according to claim 2, further comprising
a display device that displays the inappropriate-work information, wherein
the controller displays, where it is determined that the identified work target has been conveyed to the correction zone on the basis of the detection result of the detector, the inappropriate-work information stored in the second storage device on the display device.

4. The work monitoring system according to claim 2, wherein
the controller creates, on the basis of the tracking data stored in the first storage device and the inappropriate-work information stored in the second storage device, inappropriate-work correction information indicating content of work for correcting the inappropriate work.

5. The work monitoring system according to claim 4, further comprising
a display device that displays the inappropriate-work information and the inappropriate-work correction information, wherein
the controller displays, where it is determined that the identified work target has been conveyed to the correction zone on the basis of the detection result of the detector, the inappropriate-work information stored in the second storage device and the created inappropriate-work correction information on the display device.

6. The work monitoring system according to claim 1, wherein
the work target includes a container, a lamp being attached to the container,
the work is work of putting an article into the container to which the work instruction has been given, the article being kept in an article box prepared in a work zone, a lamp being attached to the article box, and
the work instruction is performed by operations of the lamp attached to the container and the lamp attached to the article box.

7. The work monitoring system according to claim 6, wherein
the controller operates, where it is determined that the container that is the identified work target has been conveyed to the correction zone on the basis of the detection result of the detector, the lamp attached to the container to notify that the inappropriate work has been performed.

8. The work monitoring system according to claim 6, wherein
the controller
monitors, on the basis of an image of a worker who works in the work zone captured by the monitoring camera, whether or not an article is kept in the container of the work target to which the work instruction has been given,
determines, where the article is kept in a container of a work target other than the work target to which the work instruction has been given, that inappropriate work has been performed, on the basis of the monitoring result, and
identifies the work target in which the article is kept due to the inappropriate work and the work target to which the work instruction has been given.

9. The work monitoring system according to claim 6, wherein
a radio tag that stores information for identifying the container is attached to the container, and
the detector includes a reader that communicates with the radio tag and reads the information stored in the radio tag.

10. A work monitoring method for a work monitoring system that monitors work of a worker on a work target conveyed from a work zone where the work is performed in accordance with a predetermined work instruction to a correction zone where the work is corrected, comprising:
installing a monitoring camera at a position capable of capturing an image of a behavior of the worker on the work target;
storing, in a storage device, tracking data including content of the work instruction for the worker in association with the work target to track the behavior of the worker;
monitoring the work of the worker in the work zone on the basis of the image captured by the monitoring camera;
determining, on the basis of a result of monitoring the work and the tracking data stored in the storage device, whether or not inappropriate work different from work designated by the work instruction has been performed on the work target by the worker;
identifying, where it is determined that the inappropriate work on the work target has been performed, the work target on which the inappropriate work has been performed, on the basis of the result; and
causing, where it is detected by a detector that the identified work target has been conveyed to the correction zone, a notifier to notify that the inappropriate work has been performed on the identified work target.
